(19) United States
(12) Patent Application Publication
(10) Pub. No.: US 2024/0262299 A1
(43) Pub. Date: Aug. 8, 2024

(54) Hit-And-Run Dash Camera Device

(71) Applicant: Malkia Blanchard, Quincy, IL (US)

(72) Inventor: Malkia Blanchard, Quincy, IL (US)

(21) Appl. No.: 18/397,015

(22) Filed: Dec. 27, 2023

Related U.S. Application Data
(60) Provisional application No. 63/442,797, filed on Feb. 2, 2023.

(51) Int. Cl. B60R 11/04; B60K 35/28; B60R 11/00

(52) U.S. Cl. CPC B60R 11/04; B60K 35/28; B60K 2360/165; B60K 2360/176; B60K 2360/21; B60K 2360/589; B60R 2011/0026; B60R 2011/0056; B60R 2011/0063; B60R 2300/101; B60R 2300/103; B60R 2300/106; B60R 2300/404; B60R 2300/8073

(57) ABSTRACT

A hit-and-run dash camera device is provided that has a plurality of sensors. The sensors may be triggered by specific distance and speed elements commonly found before, during, or after a hit-and-run collision. Triggering of the sensors causes at least one camera of the device to begin recording to capture a fleeing vehicle.

### CROSS-REFERENCE TO RELATED APPLICATION

The present application claims priority to, and the benefit of, U.S. Provisional Application No. 63/442,797, which was filed on Feb. 2, 2023, and is incorporated herein by reference in its entirety.

### FIELD OF THE INVENTION

The present invention relates generally to the field of cameras. More specifically, the present invention relates to a hit-and-run dash camera device that begins automatically recording photo/video in the event that a hit-and-run occurs on the vehicle the device is attached to. Accordingly, the present disclosure makes specific reference thereto. Nonetheless, it is to be appreciated that aspects of the present invention are also equally applicable to other like applications, devices, and methods of manufacture.

### BACKGROUND

When an automobile accident occurs, the aftermath can be chaotic and overwhelming for those involved. Among the many distressing scenarios that may unfold, one of the most undesirable occurrences is when the perpetrator of the accident decides to flee the scene, leaving the victims and their damaged vehicles behind. In such a situation, the hit-and-run driver creates a series of complications for the other innocent parties involved in the accident. The owner(s) of the other vehicle(s) affected by the accident are left in a state of distress and uncertainty.

Without the vital information about the fleeing driver, they face tremendous challenges in the process of identifying and obtaining the necessary insurance details to initiate an insurance claim. The absence of the responsible party leaves them with limited options to pursue compensation for their property damages and potential injuries sustained during the collision. This can lead to a financial burden that the innocent party may not be prepared to bear, especially if their insurance coverage proves insufficient to cover all the costs. Moreover, hit-and-run accidents hinder the investigation and resolution process for law enforcement and insurance companies. With the perpetrator evading responsibility, it becomes challenging to accurately determine the sequence of events leading up to the accident. Critical details may go unreported, impeding the ability to hold the at-fault driver accountable and establish liability, which can further delay the claims process.

Therefore, there exists a long-felt need in the art for a device that can be used to capture and identify hit-and-run drivers. There also exists a long-felt need in the art for a hit-and-run dash camera device that is automatically activated in the event of a hit-and-run. In addition, there exists a long-felt need in the art for a hit-and-run dash camera device that is automatically activated in the event of a hit-and-run and wherein the device can capture photos/videos from multiple angles.

The subject matter disclosed and claimed herein, in one embodiment thereof, comprises a hit-and-run dash camera device. The device is comprised of at least one camera. The camera may be activated by at least one sensor. The sensor may be a distance sensor in one embodiment that causes the camera to begin recording photo/video when a vehicle is detected closer to the device than a programmed threshold distance. In another embodiment, the device may also have an acceleration sensor wherein after an acceleration threshold is exceeded (after the distance threshold has also been exceeded) the camera begins recording photo/video to catch a fleeing vehicle after a hit-and-run.

In this manner, the hit-and-run dash camera device of the present invention accomplishes all the foregoing objectives and provides a device that can be used to capture and identify hit-and-run drivers. During use, the device is automatically activated via the sensor(s) in the event of a hit-and-run. In addition, the multiple cameras of the device allow the device to capture photos/videos from multiple angles.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a hit-and-run dash camera device designed to take photos/video of a fleeing vehicle (from the vehicle that was hit) before, during, and/or after a hit-and-run crash has occurred. During use, the device can be attached to a front windshield, a rear windshield, or any other surface of a vehicle via at least one fastener.

A body of the device attaches to at least one housing, wherein the housing provides glare reduction for at least one camera lens of the body. The body attaches to the housing via at least one fastener that allows the body to be rotated at least 90 degrees relative to the housing along the axis of the fastener to position the camera lens of the body appropriately during use in order to capture a roadway in front of the vehicle the device is attached to.

The body is comprised of at least one (but preferably two) camera lens, sensor, status light, button, flash, and distance sensor. In the preferred embodiment, both sides of the body have said components to allow the device to capture vehicle impacts via photo/video from the front and rear, as well as photo/video of the inside of the vehicle the device is attached to and the roadway simultaneously.

The camera begins to take photo/video automatically in at least two scenarios. In the first scenario, the body is comprised of at least one distance sensor which has a threshold distance (i.e., 3 feet), wherein once the threshold distance is exceeded by a nearby vehicle (i.e., during a vehicle collision) the camera begins capturing continuous or intermittent photos/video in order to record any vehicle collisions as well as the license plate (among other visual details) of any vehicle involved said collision.

In another embodiment, the body is comprised of at least one acceleration sensor that may be comprised of a threshold acceleration (i.e., 15 mph) wherein once a vehicle is detected as accelerating beyond this threshold (i.e., after fleeing an accident) and/or after the threshold distance of the sensor has been exceeded, the camera begins capturing continuous or intermittent photos/video in order to capture any subsequent vehicle collisions as well as the license plate (among other visual details) of any vehicle involved said collision that is fleeing.

The present invention is also comprised of a method of using the device. First, a device is provided comprised of a fastener and a rotatable body with at least one camera lens, and at least one sensor which may be a distance sensor and/or an acceleration sensor. Then, the device can be attached to a vehicle interior or exterior surface via the fastener. Next, footage taken by the camera before, during, and/or after a hit-and-run collision can be reviewed using a mobile application (or memory card).

Accordingly, the hit-and-run dash camera device of the present invention is particularly advantageous as it provides a device that can be used to capture the identification of hit-and-run drivers. During use, the device is automatically activated via the sensor(s) in the event of a hit-and-run. In addition, the multiple cameras of the device allow the device to capture photos/videos from multiple angles. In this manner, the hit-and-run dash camera device provides a solution to capturing the identification of hit-and-run drivers.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a hit-and-run dash camera device of the present invention in accordance with the disclosed architecture; and

FIG. 2 illustrates a flowchart of a method of using one potential embodiment of a hit-and-run dash camera device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used to capture the identity of hit-and-run drivers. There also exists a long-felt need in the art for a hit-and-run dash camera device that is automatically activated in the event of a hit-and-run crash. In addition, there exists a long-felt need in the art for a hit-and-run dash camera device that is automatically activated in the event of a hit-and-run crash and wherein the device can capture photos/videos from multiple angles.

The present invention, in one exemplary embodiment, is comprised of a hit-and-run dash camera device. During use, the device takes photos/video of a fleeing vehicle (from the vehicle that was hit) before, during, and/or after a hit-and-run has occurred. The device can be attached to a front windshield, a rear windshield, or any other surface of a vehicle via at least one fastener.

A body of the device attaches to at least one housing. The housing provides glare reduction for at least one camera lens of the body. The body attaches to the housing via at least one fastener that allows the body to be rotated at least 90 degrees relative to the housing along the axis of the fastener to position the camera lens of the body appropriately during use in order to capture a roadway in front of the vehicle the device is attached to.

The body is comprised of at least one (but preferably two) camera lens, sensor, status light, button, flash, and distance sensor. In the preferred embodiment, both sides of the body have said components to allow the device to capture vehicle impacts via photo/video from the front and rear, as well as photo/video of the inside of the vehicle the device is attached to and the roadway simultaneously.

The camera begins to take photo/video automatically in at least two scenarios. In the first scenario, the body is comprised of at least one distance sensor which has a threshold distance (i.e., 3 feet), wherein once the threshold distance is exceeded by a nearby vehicle (i.e., during a vehicle collision) the camera begins capturing continuous or intermittent photos/video in order to record any vehicle collisions as well as the license plate (among other visual details) of any vehicle involved said collision.

In another embodiment, the body is comprised of at least one acceleration sensor that may be comprised of a threshold acceleration (i.e., 15 mph) wherein once a vehicle is detected as accelerating beyond this threshold (i.e., after fleeing an accident) after the threshold distance of the sensor has been exceeded, the camera begins capturing continuous or intermittent photos/video in order to capture any subsequent vehicle collisions as well as the license plate (among other visual details) of any vehicle involved said collision that is fleeing.

The present invention is also comprised of a method of using the device. First, a device is provided comprised of a fastener and a rotatable body with at least one camera lens, and at least one sensor which may be a distance sensor and/or an acceleration sensor. Then, the device can be attached to a vehicle interior or exterior surface via the fastener. Next, footage taken by the camera before, during, and/or after a hit-and-run collision can be reviewed using a mobile application (or memory card).

Accordingly, the hit-and-run dash camera device of the present invention is particularly advantageous as it provides a device that can be used to capture the identity of hit-and-run drivers. During use, the device is automatically activated via the sensor(s) in the event of a hit-and-run. In addition, the multiple cameras of the device allow the device to capture photos/videos from multiple angles. In this manner, the hit-and-run dash camera device provides a solution to capturing the identification of hit-and-run drivers.

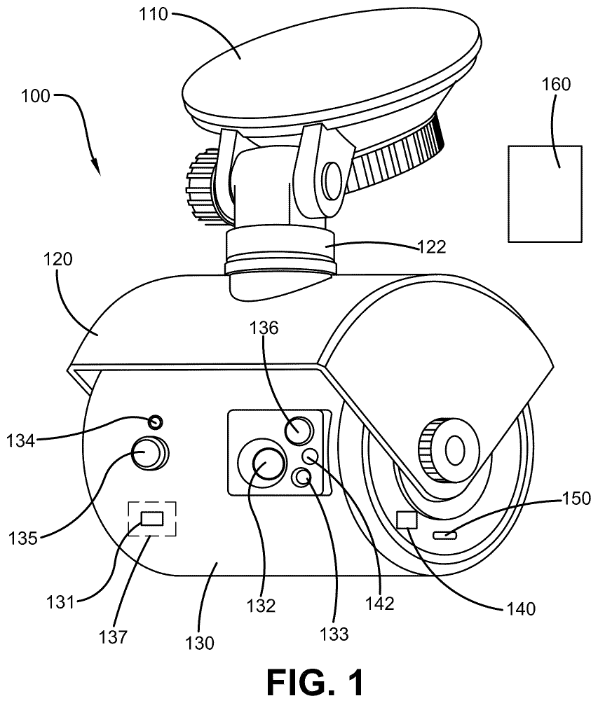

Referring initially to the drawings, FIG. 1 illustrates a perspective view of one potential embodiment of a hit-and-run dash camera device 100 of the present invention in accordance with the disclosed architecture. The device 100 is designed to take photos/video of a fleeing vehicle (from the vehicle that was hit) before, during, and/or after a hit-and-run has occurred. During use, the device 100 can be attached to a front windshield, a rear windshield, or any other surface of a vehicle via at least one fastener 110. The fastener 110 is preferably a suction cup fastener. However, the fastener 110 may be any fastener type known in the art such as, but not limited to, magnetic, hook and loop, adhesive, etc., such that the device 100 can attach to any exterior or interior vehicle surface.

A body 130 of the device 100 attaches to at least one housing 120 via at least one fastener 122. The housing 120 provides glare reduction for at least one camera lens 132 of the body 130 and also protects the body 130 from impact damage. The fastener 122 is preferably, but not limited to, a threaded screw that allows the body 130 to be rotated at least 90 degrees relative to the housing 120 along the x-axis of the fastener 122. This allows a user to rotate and position the camera lens 132 of the body 130 appropriately during use in order to capture a roadway in front of the vehicle the device 100 is attached to. The fastener 122 may be any type that secures the body 130 to/within the housing 120 in a removable or non-removable fashion and that also allows the body 130 to rotate relative to the housing 120.

The housing 120 connects to the fastener 110 via at least one rotation point 122. The rotation point 122 allows the housing 120 and body 130 to rotate 360 degrees relative to the y-axis of the fastener 110. In this manner, the camera lens 132 of the body 130 can be rotated/positioned as needed during use in order to capture a roadway in front of the vehicle the device 100 is attached to and/or the interior of the vehicle it is attached to. The rotation point 122 may be any type of locking or non-locking rotating joint or connector known in the art.

The body 130 is comprised of at least one (but preferably two) camera lens 132, sensor 133, status light 134, button 135, and flash 136. In the preferred embodiment, both sides of the body 130 have at least one of said components to allow the device 100 to capture vehicle impacts via photo/video from the front and rear, as well as photo/video of the inside of the vehicle the device 100 is attached to and the roadway simultaneously.

The camera 132 may be any type of camera lens known in the art such as, but not limited to, a wide-angle lens, a night-vision lens, etc. The lens 132 begins to take photo/video automatically in at least two scenarios. In the first scenario, the body 130 is comprised of at least one distance sensor 133. The sensor 133 has a threshold distance (i.e., 3 feet), wherein once the threshold distance is exceeded (i.e., a vehicle comes closer to the vehicle the device 100 is attached to than the threshold distance) by a nearby vehicle (i.e., during a vehicle collision) the camera 132 begins capturing continuous or intermittent photos/video in order to record any vehicle collisions as well as the license plate (among other visual details) of any vehicle involved said collision.

In another embodiment, the body 130 is comprised of at least one acceleration sensor 142. The sensor 142 may be comprised of at least one threshold acceleration (i.e., 15 mph) wherein once a vehicle is detected as accelerating beyond this threshold (i.e., which would occur after fleeing an accident in a hit-and-run) and/or after the threshold distance of the sensor 133 has been exceeded, the camera 132 begins capturing continuous or intermittent photos/video in order to capture any subsequent vehicle collisions as well as the license plate (among other visual details) of any vehicle involved said collision that is fleeing.

In one embodiment, the lens 132 may also activate a continuous or intermittent white light or IR camera flash 136 to improve the quality of photos/video taken by the lens 132 in a dark environment. In addition, once the camera 132 is recording (onto at least one removable memory card 150 of any type known in the art in one embodiment), at least one status light 134 may illuminate a first color to indicate to a user that the camera 132 is recording. When not recording, the light 134 may illuminate a second color.

In one embodiment, the camera 132 may be automatically activated via at least one button 135. The button 135 may also activate at least one wireless transmitter 140 of the body 110. The transmitter 140 is preferably (but not limited to) a Bluetooth or Wi-Fi transmitter which allows photos/videos recorded by the camera 132 to be sent, viewed, and stored on a mobile application 160.

The device 100 is powered by at least one battery 137. The battery 137 may be a disposable or rechargeable battery. In one embodiment, the battery 137 can be recharged via at least one charging port 131 located on the body 130. The charging port 131 may be any type but is preferably a USB port.

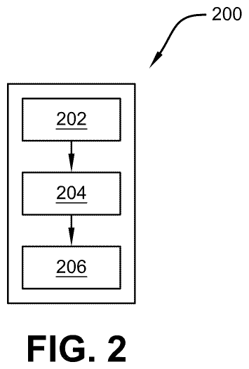

The present invention is also comprised of a method of using 200 the device 100, as seen in FIG. 2. First, a device 100 is provided comprised of a fastener 110 and a rotatable body 130 with at least one camera lens 132, and at least one sensor which may be a distance sensor 133 and/or an acceleration sensor 142 [Step 202]. Then, the device 100 can be attached to a vehicle interior or exterior surface via the fastener 110 [Step 204]. Next, footage taken by the camera 132 before, during, and/or after a hit-and-run collision can be reviewed using a mobile application 160 (or memory card 150) [Step 206].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “hit-and-run dash camera device” and “device” are interchangeable and refer to the hit-and-run dash camera device 100 of the present invention.

Notwithstanding the foregoing, the hit-and-run dash camera device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the hit-and-run dash camera device 100 as shown in the FIGS. are for illustrative purposes only, and that many other sizes and shapes of the hit-and-run dash camera device 100 are well within the scope of the present disclosure. Although the dimensions of the hit-and-run dash camera device 100 are important design parameters for user convenience, the hit-and-run dash camera device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A hit-and-run dash camera device comprising:
a body comprised of a camera and a distance sensor; and
a first fastener.

2. The hit-and-run dash camera device of claim 1, wherein the distance sensor is comprised of a threshold distance that when exceeded causes the camera to begin capturing a photo or a video.

3. The hit-and-run dash camera device of claim 1, wherein the first fastener is comprised of a suction cup.

4. The hit-and-run dash camera device of claim 1, wherein the first fastener is comprised of an adhesive fastener.

5. The hit-and-run dash camera device of claim 1, wherein the body is attached to a housing via a second fastener.

6. The hit-and-run dash camera device of claim 5, wherein the body can rotate 90 degrees relative to a x-axis of the second fastener.

7. The hit-and-run dash camera device of claim 5, wherein the housing attaches to the first fastener via a rotation point.

8. The hit-and-run dash camera device of claim 7, wherein the housing can rotate 360 degrees around a Y-axis of the fastener via the rotation point.

9. A hit-and-run dash camera device comprising:
a body comprised of a camera, a distance sensor comprised of a threshold distance, an
acceleration sensor comprised of a threshold acceleration;
a first fastener; and
a battery.

10. The hit-and-run dash camera device of claim 9, wherein after the threshold distance and the threshold acceleration have been exceeded, the camera begins capturing a photo or a video.

11. The hit-and-run dash camera device of claim 9, wherein the camera is comprised of a wide-angle lens.

12. The hit-and-run dash camera device of claim 9, wherein the camera is comprised of a night vision lens.

13. The hit-and-run dash camera device of claim 9, wherein the camera is comprised of a flash.

14. The hit-and-run dash camera device of claim 1, wherein the first fastener is comprised of a suction cup.

15. The hit-and-run dash camera device of claim 1, wherein the first fastener is comprised of an adhesive fastener.

16. A method of using a hit-and-run dash camera device, the method comprising the following steps:
providing a hit-and-run dash camera device comprised of a fastener, and a body comprised of a camera and a sensor;
attaching the hit-and-run dash camera device to a vehicle interior surface or a vehicle exterior surface; and
reviewing a footage taken by the camera via a mobile application.

17. The method of using a hit-and-run dash camera device of claim 16, wherein the body can be rotated 360 degrees relative to the Y-axis of the fastener.

18. The method of using a hit-and-run dash camera device of claim 16, wherein the body is attached to a housing.

19. The method of using a hit-and-run dash camera device of claim 18, wherein the housing is attached to the fastener.

20. The method of using a hit-and-run dash camera device of claim 16, wherein the hit-and-run dash camera device is comprised of a transmitter.
